(19) United States
(12) Patent Application Publication
(10) Pub. No.: US 2014/0104779 A1
(43) Pub. Date: Apr. 17, 2014

(54) MOUNTING APPARATUS FOR DATA STORAGE DEVICE

(71) Applicants: Hon Hai Precision Industry Co., Ltd., New Taipei (TW); Hong Fu Jin Precision Industry (ShenZhen) Co. Ltd., Shenzhen (CN)

(72) Inventors: CHIH-HAO YANG, New Taipei (TW); XIANG-KUN ZENG, Shenzhen (CN); ER-WEI LU, Shenzhen (CN); ZHI-QIANG ZUO, Shenzhen (CN)

(21) Appl. No.: 13/923,934

(22) Filed: Jun. 21, 2013

(30) Foreign Application Priority Data
Oct. 12, 2012 (CN) 2012103857008

(51) Int. Cl. G06F 1/18

(52) U.S. Cl. CPC G06F 1/187
USPC 361/679.33; 248/316.8

(57) ABSTRACT

The present disclosure provides a mounting assembly, which includes a data storage device and a bracket receiving the data storage device. Two locking portions are located on opposite sides of the data storage device. The bracket includes a first side plate and the second side plate, each defining a locking hole. The locking holes of the first side plate and the second side plate receive the two locking portions to secure the data storage device in the bracket.

### BACKGROUND

1. Technical Field

The present disclosure relates to mounting apparatuses, and more particularly to a mounting apparatus for a data storage device.

2. Description of Related Art

A data storage device is provided in a computer system for storing data. Conventionally, the data storage device is fixed to a bracket of the computer system with screws, which is very inconvenient when assembling or disassembling the data storage device. Therefore, there is room in the art for improvement.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a mounting apparatus and a data storage device in accordance with an embodiment.

FIG. 2 is an assembled view of assembling the mounting apparatus and the data storage device of FIG. 1.

FIG. 3 is a cross-sectional, cut away view of the assembly of the mounting apparatus and the data storage device of FIG. 1, taken along a line III-III.

FIG. 4 is similar to FIG. 3, but shows an alternative embodiment of the assembly of the mounting apparatus and the data storage device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

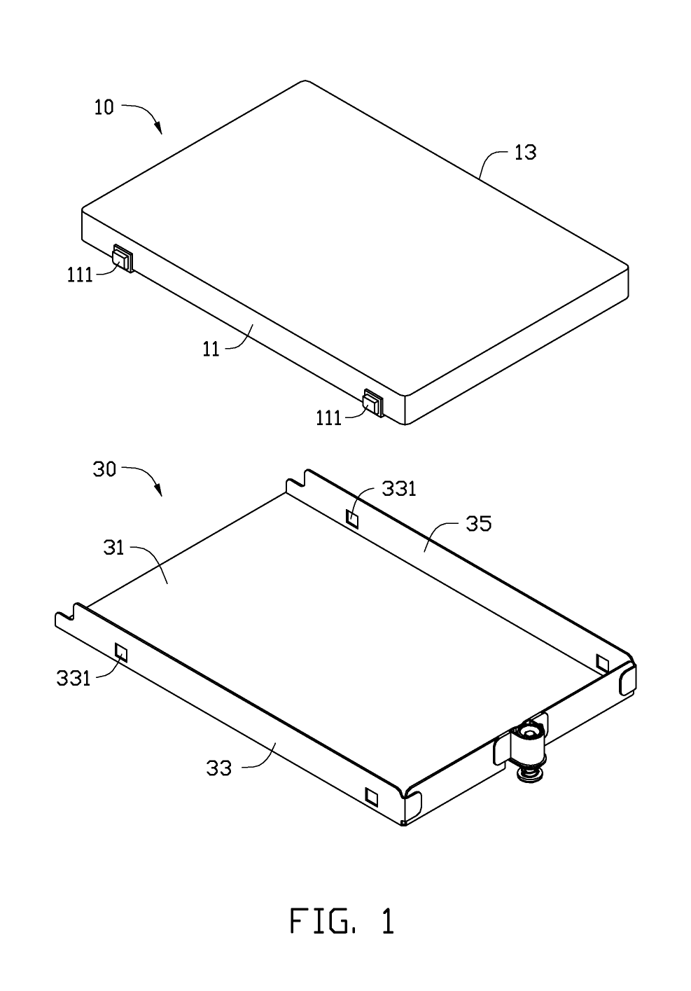

FIG. 1 illustrates a mounting apparatus for securing a data storage device 10. The data storage device 10 may be, for example, a hard disk drive, a CD-ROM drive, or a floppy disk drive, or a solid state disk, etc.

The data storage device 10 comprises a first sidewall 11 and a second sidewall 13 opposite to the first sidewall 11. The first sidewall 11 and the second sidewall 13 are substantially parallel to each other. Two locking portions 111 protrude from each of the first sidewall 11 and the second sidewall 13. Each of the two locking portions 111 comprises a first outer surface 1111 and a guiding surface 1113 connected to the first outer surface 1111. The first outer surface 1111 is substantially parallel to the first sidewall 11 and the second sidewall 13. The guiding surface 1113 is substantially arc-shaped. A thickness of each of the two locking portions 111 of each of the first sidewall 11 and the second sidewall 13 is 0.575 mm.

The mounting apparatus comprises a bracket 30. The bracket 30 comprises a bottom plate 21, a first side plate 33, and a second side plate 35. The first side plate 33 and the second side plate 35 extends upward from opposite edges of the bottom plate 31. The first side plate and the second side plate 35 are substantially parallel to each other and perpendicular to the bottom plate 31. Each of the first side plate 33 and the second side plate 35 defines two locking holes 331, configured for receiving the two locking portions 111 of each of the first sidewall 11 and the second sidewall 13. The first side plate 33 comprises a second outer surface 333, and the second side plate 35 comprises a second outer surface (not shown). A thickness of each of the first side plate 33 and the second side plate 35 is 0.4 mm.

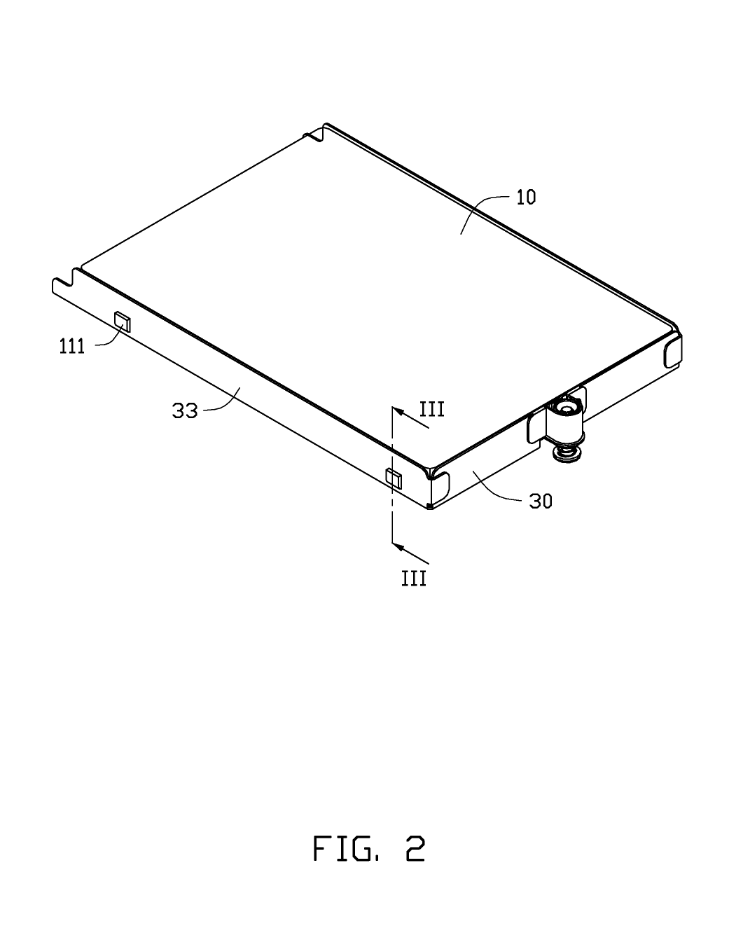

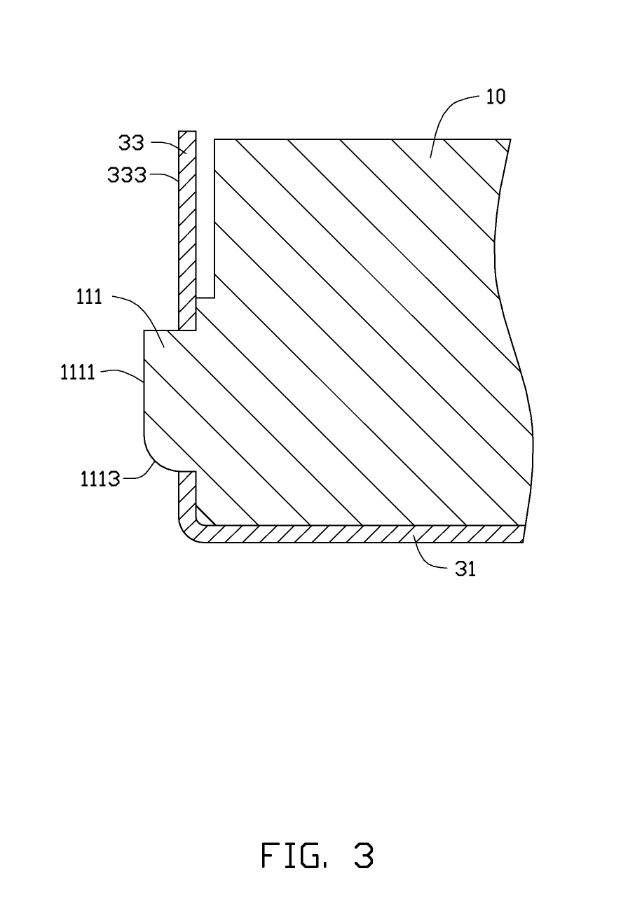

In assembly, the data storage device 10 is located on top of the first side plate 33 and the second side plate 35, until the guiding surface 1113 of each of the two locking portions 111 abuts on a top edge of each of the first side plate 33 and the second side plate 35. The data storage device 10 is further moved down, and the guiding surface 1113 resiliently deform the first side plate 33 and the second side plate 35 outward. If the two locking portions 111 of each of the first sidewall 11 and the second sidewall 13 are aligned with the two locking holes 331, the first side plate 33 and the second side plate 35 rebound and engage the two locking portions 111 of each of the first sidewall 11 and the second sidewall 13 in the two locking holes 331 of each of the first side plate 33 and the second side plate 35 (see FIGS. 2 and 3). Therefore, the data storage device 10 is secured in the bracket 30 between the first side plate 33 and the second side plate 35. A first distance between the second outer surface 333 of the first side plate 33 and the first outer surface 1111 of each of the two locking portions 111 engaged with the first side plate 33 is in a range from about 0.3 mm to 0.4 mm. A second distance between the third outer surface (not labeled) of the second side plate 35 and the first outer surface 1111 of each of the two locking portions 111 engaged with the second side plate 35 is in a range from about 0.3 mm to 0.4 mm.

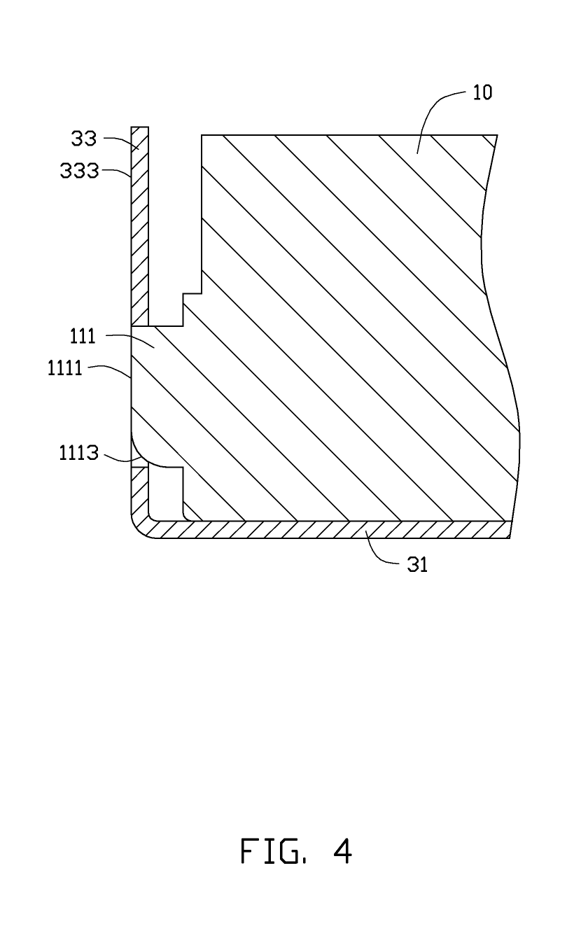

In an embodiment illustrated in FIG. 4, the second outer surface 333 of the first side plate 33 and the first outer surface 1111 of each of the two locking portions 111 engaged with the first side plate 33 are arranged in a first plane, and the third outer surface of the second side plate 35 and the first outer surface 1111 of each of the two locking portions 111 engaged with the second side plate 35 are arranged in a second plane.

When the data storage device 10 is removed from the bracket 30, the first side plate 33 or the second side plate 35 is resiliently deformed, until the two locking portions 111 are disengaged from the two locking holes 331 of the first side plate 33 or the second side plate 35. The data storage device 10 can be removed out of the bracket 30.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A mounting apparatus assembly comprising:
a data storage device, two locking portions located on opposite sides of the data storage device; and
a bracket, the bracket comprising a bottom plate, a first side plate, and a second side plate; and the first side plate and the second side plate extend from opposite edges of the bottom plate, and each of the first side plate and the second side plate defines a locking hole;
wherein each of the two locking portions is locked in the locking hole of each of the first side plate and the second side plate, to secure the data storage device between the first side plate and the second side plate; and at least one of the first side plate and the second side plate is resiliently deformable, relative to the bottom plate, to disengage each of the two locking portions from the locking hole of each of the first side plate and the second side plate.

2. The mounting apparatus assembly of claim 1, wherein each of the two locking portions comprises a guiding surface, for conveniently inserting the data storage device between the first side plate and the second side plate.

3. The mounting apparatus assembly of claim 2, wherein the guiding surface is substantially arc-shaped.

4. The mounting apparatus assembly of claim 1, wherein each of the two locking portions comprises a first outer surface; the first side plate comprises a second outer surface; the second side plate comprises a third outer surface; the first outer surface, the second outer surface, and the third outer surface are substantially parallel to each other.

5. The mounting apparatus assembly of claim 4, wherein a distance between the second outer surface and the first outer surface of one of the two locking portions engaged with the first side plate or between the third outer surface and the first outer surface of one of the two locking portions engaged with the second side plate is in arrange from 0.3 mm to 0.4 mm.

6. The mounting apparatus assembly of claim 4, wherein the second outer surface and the first outer surface of the one of the two locking portions engaged with the first side plate are located in a first plane; and the third outer surface of the one of the two locking portions engaged with the second side plate are located in a second plane.

7. The mounting apparatus assembly of claim 1, wherein a thickness of each of the two locking portions is 0.575 mm.

8. The mounting apparatus assembly of claim 1, wherein a thickness of each of the first side plate and the second side plate is 0.4 mm.

9. A mounting apparatus assembly comprising:
a locking portion configured for being attached to a data storage device; and
a bracket, the bracket comprising a bottom plate, a first side plate, and a second side plate; the first side plate and the second side plate extend from the bottom plate; and the first side plate defines a locking hole;
wherein the locking portion is locked in the locking hole, to secure the data storage device between the first side plate and the second side plate; and the first side plate is resiliently deformable relative to the bottom plate to disengage the locking portion from the locking hole the first side plate, for removing the data storage device from the bracket.

10. The mounting apparatus assembly of claim 9, wherein the locking portion comprises a guiding surface, for conveniently inserting the data storage device in between the first side plate and the second side plate.

11. The mounting apparatus assembly of claim 10, wherein the guiding surface is substantially arc-shaped.

12. The mounting apparatus assembly of claim 9, wherein the locking portion comprises first outer surface; the first side plate comprises a second outer surface; and the first outer surface and the second outer surface are substantially parallel to each other.

13. The mounting apparatus assembly of claim 12, wherein a distance between the second outer surface and the first outer surface is in arrange from 0.3 mm to 0.4 mm.

14. The mounting apparatus assembly of claim 9, wherein a thickness of the locking portion is 0.575 mm.

15. The mounting apparatus assembly of claim 9, wherein a thickness of each of the first side plate and the second side plate is 0.4 mm.
